(19) United States
(12) Patent Application Publication
(10) Pub. No.: US 2009/0327354 A1
(43) Pub. Date: Dec. 31, 2009

(54) NOTIFICATION AND SYNCHRONIZATION OF UPDATED DATA

(75) Inventors: Kevin Resnick, Redmond, WA (US); Selva Nalliah, Redmond, WA (US); Jeroen de Borst, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/146,472

(22) Filed: Jun. 26, 2008

(51) Int. Cl. G06F 17/30

(52) U.S. Cl. 707/201; 707/E17.005

(57) ABSTRACT

Techniques for notification and synchronization are described. Some techniques may comprise receiving a synchronization request and establishing an updating session connection. The updating session may be based on a delay interval parameter specifying a length of a delay interval and a collection parameter specifying one or more collections to be synchronized. When data for the collections to be synchronized is unchanged, the updating session may be maintained, and the synchronization request may be kept pending. Upon receiving a notification from a data store during the delay interval that updated data is available for one or more of the collections to be synchronized, a synchronization session connection is established with the data store to retrieve the updated data. A notification and synchronization message comprising the updated data may be sent as a response to the pending synchronization request. Other embodiments are described and claimed.

### BACKGROUND

Several solutions exist for synchronizing a mobile device with a computer. For example, synchronization programs may allow a mobile device to transfer items such as calendar events and electronic mail (e-mail) from a desktop personal computer (PC) or a dedicated server. Server-based e-mail solutions typically involve user-initiated or periodic polling of e-mail servers. Some server-based e-mail solutions may push e-mail messages from dedicated servers to mobile devices equipped with appropriate software. Other server-based e-mail solutions provide notifications to the user when synchronization is needed. For e-mail solutions that provide such notifications, multiple communications with the server are required including one communication for the user to be notified that there is a change and then a subsequent communication initiated by the user to synchronize the data which has changed.

In mobile applications, the client generally may be a cellular telephone that is issuing requests over the network of a mobile operator. Connections over these networks are expensive in terms of monetary cost incurred by the user and in terms of the power required by the device. Thus, it is advantageous to send as little data as possible so that a synchronization solution is not prohibitively expensive and so that it does not overly impact the battery life of the device. Accordingly, improved notification and synchronization techniques are needed to solve these and other problems.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments are directed to notification and synchronization techniques. Some techniques may comprise receiving a synchronization request from a synchronization agent and establishing an updating session connection with the synchronization agent. The updating session may be based on a delay interval parameter specifying a length of a delay interval and a collection parameter specifying one or more collections to be synchronized. When data for the collections to be synchronized is unchanged since the last synchronization, the updating session may be maintained, and the synchronization request may be kept pending. Upon receiving a notification from a data store during the delay interval that updated data is available for one or more of the collections to be synchronized, a synchronization session connection is established with the data store to retrieve the updated data. A notification and synchronization message comprising the updated data may be sent to the synchronization agent as a response to the pending synchronization request. Other embodiments are described and claimed.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

FIG. 1 illustrates an embodiment of an operating environment.

FIG. 2 illustrates an embodiment of a computing device.

FIG. 3 illustrates an embodiment of a synchronization application.

FIG. 4 illustrates an embodiment of a message flow.

FIG. 5 illustrates an embodiment of a logic flow.

FIG. 6 illustrates an embodiment of an article.

### DETAILED DESCRIPTION

Various embodiments include physical or logical structures arranged to perform certain operations, functions or services. The structures may comprise physical structures, logical structures or a combination of both. The physical or logical structures are implemented using hardware elements, software elements, or a combination of both. Descriptions of embodiments with reference to particular hardware or software elements, however, are meant as examples and not limitations. Decisions to use hardware or software elements to actually practice an embodiment depends on a number of external factors, such as desired computational rate, power levels, heat tolerances, processing cycle budget, input data rates, output data rates, memory resources, data bus speeds, and other design or performance constraints. Furthermore, the physical or logical structures may have corresponding physical or logical connections to communicate information between the structures in the form of electronic signals or messages. The connections may comprise wired and/or wireless connections as appropriate for the information or particular structure. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Various notification and synchronization techniques are provided. Some techniques may comprise receiving a synchronization request from a synchronization agent and establishing an updating session connection with the synchronization agent based on a delay interval parameter and a collection parameter associated with the synchronization request. The delay interval parameter may specify a length of a delay interval and the collections parameter may specify one or more collections to be synchronized. The techniques may comprise maintaining the updating session connection and keeping the synchronization request pending when data for the one or more collections to be synchronized is unchanged.

In various implementations, a notification may be received from a data store during the delay interval indicating that updated data is available for one or more of the collections to be synchronized. In response to the notification, a synchronization session connection may be established with the data store for retrieving the updated data. Upon receiving the updated data, a notification and synchronization message comprising the updated data may be sent to the synchronization agent as a response to the pending synchronization request

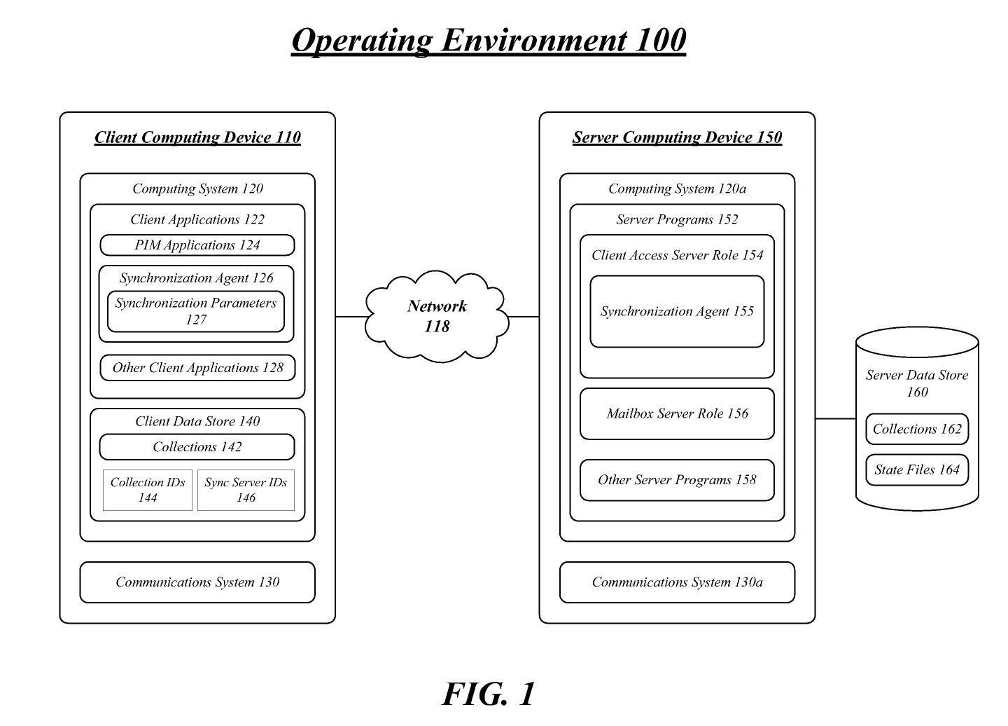

FIG. 1 illustrates a block diagram for an operating environment 100 suitable for practicing the various embodiments. The operating environment 100 may comprise elements designed for implementation by a single entity environment or a multiple entity distributed environment. Each element may be implemented as a hardware element, software element, or any combination thereof, as desired for a given set of design parameters or performance constraints. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include any software components, programs, applications, computer programs, application programs, system programs, machine programs, operating system software, middleware, firmware, software modules, routines, subroutines, functions, methods, interfaces, software interfaces, application program interfaces (API), instruction sets, computing code, computer code, code segments, computer code segments, words, values, symbols, or any combination thereof.

As used herein the terms “system,” “subsystem,” “component,” and “module” are intended to refer to a computer-related entity, comprising either hardware, a combination of hardware and software, software, or software in execution. For example, a component can be implemented as a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers as desired for a given implementation. The embodiments are not limited in this context.

In the example illustrated in FIG. 1, the operating environment 100 may comprise, among other elements, a client computing device 110 and a server computing device 150. The computing devices 110, 150 may be implemented utilizing any suitable electronic device having computing capabilities and communications capabilities in accordance with the described embodiments. Examples for computing devices 110, 150 may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. Although the operating environment 100 as shown in FIG. 1 has a limited number of nodes in a certain topology, it may be appreciated that the operating environment 100 may include more or less nodes in alternate topologies as desired for a given implementation.

The computing devices 110, 150 may be communicatively coupled via a network 118 and appropriate wireless or wired communications media. The computing devices 110, 150 may communicate information over the network 118 and coordinate operations between each other, which may involve the unidirectional or bidirectional exchange of information. The network 118 may comprise a packet-switched network, a circuit-switched network, or a combination of both. The information communicated over the network 118 can be implemented as data messages sent across various network interfaces. Exemplary network interfaces include parallel interfaces, serial interfaces, and bus interfaces.

In general, the computing devices 110, 150 each may comprise or be implemented by any suitable type of computing device having computing capabilities and communications capabilities in accordance with the described embodiments. To implement such capabilities, the client computing device 110 and server computing device 150 may comprise respective computing systems 120, 120a and communications system 130, 130a. The computing systems 120, 120a may include various computing elements, such as one or more processors, co-processors, memory units, chipsets, controllers, peripherals, interfaces, oscillators, timing devices, video cards, audio cards, multimedia input/output (I/O) components, and so forth. The communications systems 130, 130a may include various communications elements, such as a transmitter, receiver, transceiver, radio, network interface, baseband processor, antenna, amplifiers, filters, and so forth.

The computing systems 120, 120a may implement, among other elements, respective client applications 122 and server programs 152. The client applications 122 and the server programs 152, and their included elements, may comprise or be implemented by one or more types of application programs, software components, program modules, and/or program data supporting operation of the client computing device 110 and the server computing device 150 in accordance with the described embodiments.

In the example illustrated in FIG. 1, the client applications 122 may comprise personal information manager (PIM) applications 124, a synchronization agent 126, and other applications 128 supporting operation of the client computing device 1 10. The PIM applications 124 may include, for example, one or more of an e-mail client application, calendar application, contacts application, tasks application, telephone application (e.g., cellular, voicemail, VoIP, PTT), messaging application (e.g., IM, SMS, MMS), and/or other applications in accordance with the described embodiments. Examples of other client applications 128 which may be implemented by the client computing device 110 may include, without limitation, a web browser application, networking application, word processing application, spreadsheet application, database application, media application (e.g., video player, audio player, multimedia player, digital camera, video camera, media management), location based services (LBS) application, gaming application, and others.

According to various embodiments, the synchronization agent 126 may perform one or more notification and synchronization techniques. In some implementations, for example, the synchronization agent 126 may be operative to synchronize data for the PIM applications 124 which may be stored in a client data store 140. As shown, the client data store 140 may comprise one or more collections 142 for storing data for the PIM applications 124. In various embodiments, the collections 142 may comprise individual data collections for contacts, calendar, and each e-mail folder. Each of the collections 142 may be uniquely identified by individual collection identifiers (collection IDs) 144. Each of the collection IDs 144 may comprise, for example, a unique data string of characters for each folder. Items of the collections 142 that are synchronized may be associated with individual synchronization server identifiers (sync server IDs) 146. The sync server IDs 146 may be assigned by the server computing device 150 and may comprise unique character strings used during synchronization to identify objects (e.g., message, contact, calendar items) which are stored both on the client computing device 110 and the server computing device 150.

According to various embodiments, the synchronization agent 126 may generate synchronization requests to be sent to the server computing device 150. The synchronization requests may comprise synchronization parameters 127 including, for example, a synchronization command (Cmd=Sync), a delay interval parameter, and a collections parameter. In some implementations, the synchronization parameters 127 also may comprise a synchronization key (SyncKey) for each synchronization request and/or other synchronization data in accordance with the described embodiments.

The delay interval may specify a length of a delay interval for holding the synchronization request in a pending or hanging state. In some implementations, the delay interval may be specified within a tag in the synchronization request by a positive integer value in seconds. The collections parameter may support synchronization of multiple folders and may comprise one or more of the collection IDs 144 of the corresponding collections 142 for which the synchronization agent 126 is requesting notification and synchronization. In some cases, the collections parameter may specify the collection ID for the folder to be watched for changes and the content class (e.g., e-mail, calendar, contacts, tasks, etc.) for the folder.

In some cases, the synchronization agent 126 may issue complete synchronization requests including all the synchronization parameters 126. In most cases, however, the synchronization agent 126 may issue partial synchronization requests which omit one or more synchronization parameters. In various implementations, the synchronization agent 126 and the server computing device 150 may store synchronization parameters 127 for the user based on the last synchronization. As such, if the synchronization agent 126 determines that one or more of the synchronization parameters 127 for a new synchronization request are the same as one or more of the synchronization parameters 127 used for the last synchronization, the synchronization agent 126 can omit such parameters from the synchronization request. For example, if a new synchronization request is for the same folders as the last synchronization request, the new synchronization request may comprise a partial request which omits the collections parameter. Likewise, a new synchronization request may omit the delay interval parameter when using the same delay interval that was used during the last synchronization.

Referring to the server computing device 150, the server programs 152 may support operation of the server computing device 150 in accordance with the described embodiments. In some implementations, the server programs 152 may be implemented on one physical server computer device, such as the server computing device 150. Alternately, various server programs 152 may be implemented across multiple servers, such as front-end and back-end servers, and/or located in different domains and sites to meet geographical deployment requirements and provide performance and fault tolerance when supporting a large number of users.

In the example illustrated in FIG. 1, the server programs 152 may implement one or more server roles including, for example, a client access server role 154 and a mailbox server role 156 operative to provide certain services and features for the server computing device 150. According to various embodiments, the client access server role 154 may be operative to provide access to the server computing device 150 for various types of messaging clients, and the mailbox server role 156 may be operative to host mailbox and public folder data. The server programs 152 also may comprise other server programs 158 such as other server roles (e.g., hub transport server role), web services, and/or other types of server applications in accordance with the described embodiments.

The client access server role 154 may allow the server computing device 150 to communicate with various types of messaging clients. In some implementations, the server computing device 150 may provide an interface for communicating with a client-based software program such as MICROSOFT OFFICE OUTLOOK® application software from Microsoft Corporation, Redmond, Wash. The server computing device 150 also may provide an interface for communicating with various other types of e-mail clients including, without limitation, Simple Mail Transfer Protocol (SMTP) clients, Hypertext Transfer Protocol (HTTP) clients, Messaging Application Programming Interface (MAPI) clients, Post Office Protocol 3 (POP3) clients, Internet Message Access Protocol (IMAP or IMAP4) clients, Network News Transfer Protocol (NNTP) clients, webmail clients, and so forth.

The client access server role 154 also may allow the server computing device 150 to provide various web services including web access and mobile access functionality, Internet Information Services (IIS) and Internet Server Application Programming Interface (ISAPI) applications providing SMTP, NNTP, IMAP4, and POP3 services to allow communication over a variety of Internet access protocols and HTTP-based protocols including remote procedure call (RPC) over HTTP communication. In addition to standard Internet protocols, the server computing device 150 may also support communication over proprietary or non-standard protocols when used by a company or other organization.

As shown, the client access role 154 may comprise a synchronization agent 155. According to various embodiments, the synchronization agent 155 may communicate with the synchronization agent 126 for performing one or more notification and synchronization techniques. In various implementations, for example, the synchronization agent 155 may receive a synchronization request from the synchronization agent 126 and establish an updating session connection with the synchronization agent 126 based on a delay interval parameter and a collections parameter associated with the synchronization request. The synchronization agent 155 may maintain the updating session connection and keep the synchronization request pending when data for the one or more collections to be synchronized is unchanged.

The server computing device 150 may comprise or communicate with a data store 160 storing collections 162 for users. The collections 162 may comprise items such as e-mail messages and other data stored in mailboxes and folders in accordance with the described embodiments. The data store 160 also may comprise state files 164 including user profiles. Upon receiving a synchronization request, for example, the synchronization agent 155 may communicate with the data store 160 and load a user profile from the state files 164. The user profile may be associated with a given device of the user and may comprise synchronization parameters for the last synchronization. In some embodiments, the user profile may be stored in a designated folder in the mailbox of the user. In various implementations, when the synchronization agent 126 issues partial synchronization requests which omit one or more synchronization parameters, the synchronization agent 155 may fill in the missing parameters with synchronization parameters from the user profile.

With reference to FIG. 1, the server data store 160 may be implemented by a server database for the server computing device 150, for example. While shown as being separate elements for purposes of illustration, it can be appreciated that, in some embodiments, the server data store 160 may form part of the server computing device 150. It also can be appreciated that the data store 160 for the server computing device 150 can reside in another device such as a back-end server.

According to various embodiments, the synchronization agent 155 may establish one or more subscription connections to the data store 160 based on the collections parameter and listen for notifications over the subscriptions connections. When new data is received at the data store 160 for one or more of the monitored collections during the delay interval, the synchronization agent 155 receives a notification from the data store 160 indicating that updated data is available for one or more of the collections to be synchronized. In response to the notification, the synchronization agent 155 may tear down the subscriptions and establish a synchronization session connection with the data store 160 for retrieving the updated data. After receiving the updated data, the synchronization agent 155 may send a notification and synchronization message comprising the updated data to the synchronization agent 126 as a response to the pending synchronization request.

In some embodiments, the server computing device 150 may comprise a computing device implementing a server-based software program. Accordingly, in some embodiments, one or more notification and synchronization techniques may be implemented as features within a server-based software program such as EXCHANGE ACTIVESYNC® and/or MICROSOFT EXCHANGE SERVER® from Microsoft Corporation, Redmond, Wash. It can be appreciated that the embodiments are not limited in the context and that the server computing device 150 may implement other types of e-mail applications, programs, or services including web-based e-mail applications providing access to e-mail services via a web browser.

The server computing device 150 also may comprise a computing device such as a web server implementing one or more web services. The server computing device 150 may implement various web services using platform and language independent formats designed to communicate over computer networks such as the Internet, using communications protocols such as Hypertext Transfer Protocol (HTTP), Hypertext Transfer Protocol over Secure Socket Layer (HTTPS), Simple Mail Transfer Protocol (SMTP), File Transfer Protocol (FTP), and so forth. Accordingly, in some embodiments, one or more notification and synchronization techniques may be implemented as features within a web service. It can be appreciated that the embodiments are not limited in the context and that the server computing device 150 may be implemented by other types of on-site or off-site data storage facilities.

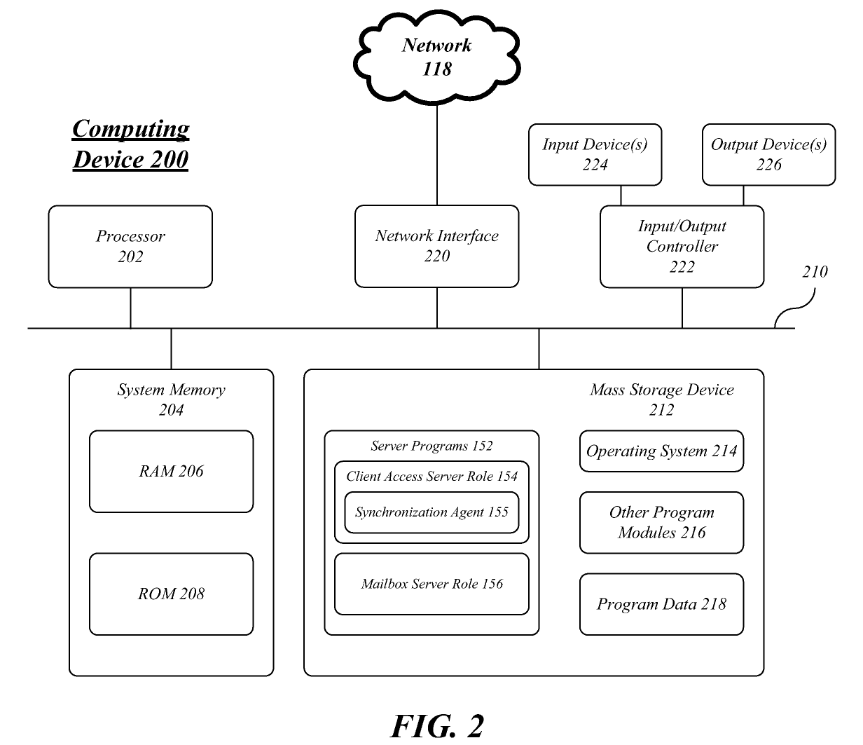

FIG. 2 provides an illustrative architecture for a computing device 200 suitable for practicing the various embodiments. The computing device 200 may be representative of, for example, the server computing device 150. As shown, the computing device 200 illustrates a conventional computing architecture for a personal or server computer, including a processing system comprising a processor 202 and a system memory 204. The system memory 204 may include, among other types of memory, a random access memory (RAM) 206 and a read-only memory (ROM) 208. An input/output (I/O) system, such as a basic I/O system (BIOS), may implement routines to assist in transferring information between elements within the computing device 200, such as during startup operations, using logic stored in the ROM 208. A system bus 210 communicatively couples all of the elements of the computing device 200 to facilitate information transfer and data processing operations.

The computing device 200 further includes a mass storage device 212 for storing an operating system 214 such as a MICROSOFT WINDOWS® operating system (e.g., WINDOWS MOBILE®) from Microsoft Corporation, Redmond, Wash. or other suitable operating system. The mass storage device 212 also may store various application programs, as described in greater detail below, as well as other program modules 216 and program data 218.

The mass storage device 212 is connected to the processor 202 through a mass storage controller (not shown) connected to the system bus 21 0. The mass storage device 212, and its associated computer-readable media, provides non-volatile storage for the computing device 200. Although the description of computer-readable media contained herein refers to a mass storage device, such as a hard disk or CD-ROM drive, it can be appreciated by those skilled in the art that computer-readable media can be any available media that can be accessed by the computing device 200. By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments, the computing device 200 may operate in a networked environment using logical connections to remote computers through a network 118 which, in some implementations, may be a Transmission Control Protocol (TCP) and Internet Protocol (IP) network, such as the Internet. The computing device 200 may connect to the network 118 through a network interface 220 (e.g., a wired or wireless network interface) connected to the system bus 210. It can be appreciated that the network 118 may comprise any type of network in accordance with the described embodiments including, without limitation, a wide area network (WAN), a local area network (LAN), and/or a cellular telephone network and that the network interface 220 may support various transport layers such as GPRS, CDMA 1xRTT, IEEE 802.11, Bluetooth® (PAN), and others for connecting to a variety of networks and/or remote computer systems.

The computing device 200 may include an I/O controller 222 for receiving and processing input from a number of input devices 224. A user may enter commands and information into the computing device 200 through various input devices 224 such as a keyboard and pointing device, such as a mouse, trackball or touch pad. Other examples of input devices 224 may include a microphone, joystick, game pad, satellite dish, scanner, or the like. The input devices 224 may be connected to the processor 202 through the I/O controller 222 that is coupled to the system bus 210, but may be connected by other interfaces and bus structures, such as a parallel port, game port or a universal serial bus (USB). The I/O controller 222 also may provide output to various output devices 224, such as a monitor or other type of display device that is connected via the I/O controller 222 to the system bus 210, a printer, speakers, and other peripheral devices.

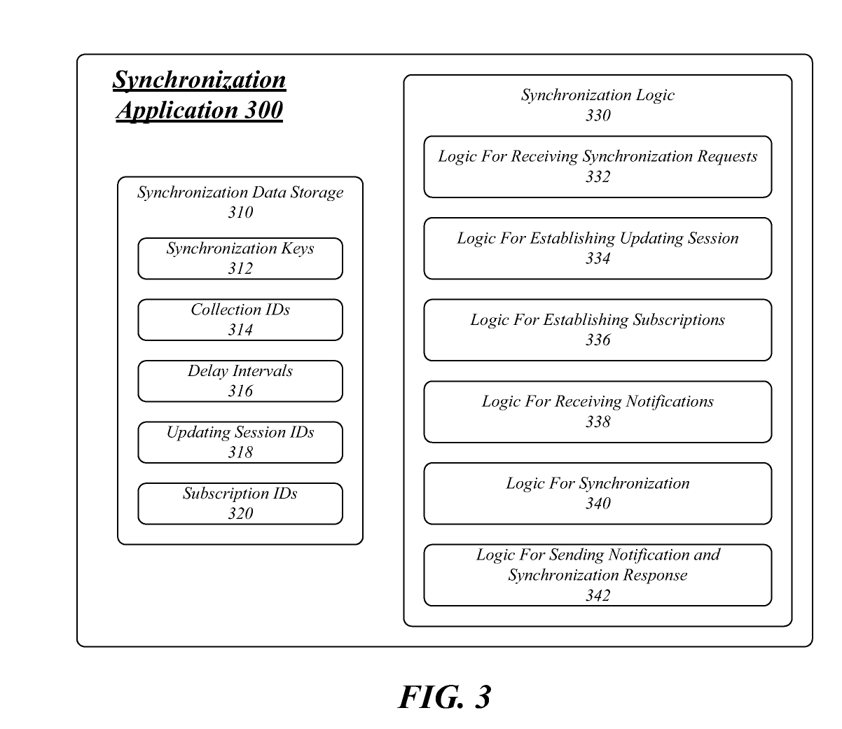

As mentioned above, a number of program modules and data files may be stored in the mass storage device 212 and RAM 206 of the computing device 200. In the example illustrated in FIG. 2, the mass storage device 212 and RAM 206 may store the operating system 214 as well as one or more server programs 152 including the client access server role 154 comprising the synchronization agent 155 and the mailbox server role 156. According to various embodiments, the synchronization agent 155 may be operative to perform one or more notification and synchronization techniques. In one embodiment, for example, the synchronization agent 155 may be implemented as described with reference to FIG. 3.

FIG. 3 illustrates one embodiment of synchronization application 300 suitable for practicing the various embodiments. With reference to FIGS. 1 and 2, in some implementations, the synchronization application 300 may operate as the synchronization agent 155 as one of the server programs 152 that reside on server computing device 150. One or more parts of the e-mail application 300 also may be implemented by application programs in the RAM 206 of the computing device 200 or in any other variation as would occur to one in the computer software art.

As shown, the synchronization application 300 may include synchronization data storage 3 10. While the synchronization data storage 310 is shown as part of the synchronization application 300 for purposes of illustration, and not limitation, it can be appreciated that the synchronization data storage 310 can reside in various locations in accordance with the described embodiments. For instance, the synchronization data storage 310 also may reside on the server computing device 150 and/or the server data store 160. As one non-limiting example, the synchronization data storage 310 of the synchronization application 300 can reside within the program data 218 of the computing device 200, either in a database and/or in one or more files. As another non-limiting example, the synchronization data storage 310 can reside all or in part in a directory specified by the user in the file system of an operating system such as the operating system 214.

In the example illustrated in FIG. 3, the synchronization data storage 310 includes synchronization keys 312, collection IDs 314, delay intervals 316, updating session IDs 318, and subscription IDs 320. The synchronization keys 312 may be received in synchronization requests received from the synchronization agent 126. The collection IDs 314 and delay intervals 316 may include synchronization parameters received in compete or partial synchronization requests from the synchronization agent 126 and/or synchronization parameters provided by user profiles loaded from the state files 164 of the data store 160.

In various embodiments, the synchronization application 300 may receive a synchronization request from the synchronization agent 126 and establish an updating session connection with the synchronization agent 126 based on a delay interval parameter and a collections parameter associated with the synchronization request. The synchronization agent 155 may maintain the updating session connection and keep the synchronization request pending when data for the one or more collections to be synchronized is unchanged. The synchronization application 300 also may establish one or more subscription connections to the data store 160 based on the collections parameter and listen for notifications over the subscriptions connections. Accordingly, the updating session IDs 318 and the subscription IDs 320 may correspond respectively to active updating sessions and subscription sessions established by the synchronization application 300.

As shown, the e-mail application 300 may include synchronization logic 330 which may be responsible for carrying out some or all of the synchronization techniques described herein. In the example illustrated in FIG. 3, the synchronization logic 330 includes logic for receiving synchronization requests 332, logic for establishing updating sessions 334, logic for establishing subscriptions 336, logic for receiving notifications 338, logic for synchronization 340, and logic for sending a notification and synchronization response 342.

In some implementations, the synchronization logic 330 may reside within the synchronization application 300 as part of the synchronization agent 155 on the server computing device 150. It can be appreciated, however, that the synchronization logic 330 can alternatively or additionally be embodied as computer-executable instructions stored on one or more types of computer-readable storage media in a variety of locations in accordance with the described embodiments.

Although the example illustrated in FIG. 3 includes a particular set of logic, it can be appreciated that the synchronization logic 330 provides an exemplary implementation of the general functionality. It is to be understood that the sequence of logic does not necessarily have to be executed in the order presented unless otherwise indicated. In addition, while the synchronization logic 330 may be described as performing a certain sequence of steps, other sequences of steps may also be performed according to alternative embodiments. Moreover, some individual steps performed by the synchronization logic 330 may include multiple sub-steps that may be performed in various sequences as appropriate to the individual step. Furthermore, additional steps may be performed or some steps may be omitted by the synchronization logic 330 depending on the particular implementation.

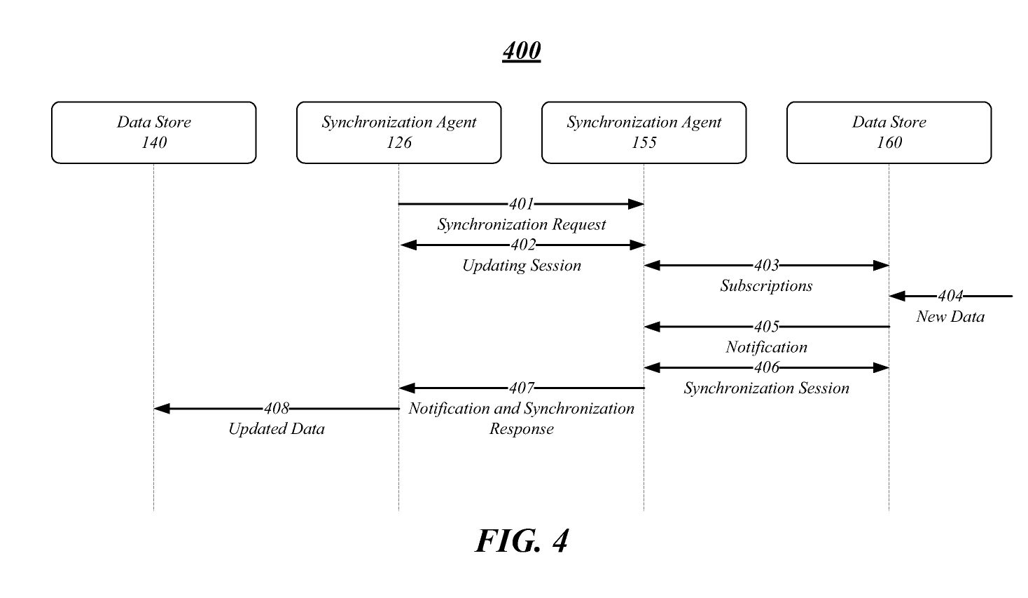

FIG. 4 illustrates one embodiment of a message flow 400 suitable for practicing the various embodiments. As shown, the message flow 400 may involve the exchange of messages 401-408 among the synchronization agents 126, 155 and data stores 140,160, which may be implemented as described above. The embodiments, however, are not limited to such implementations. Furthermore, while the example illustrated in FIG. 4 includes a particular set of messages, it can be appreciated that the message flow 400 provides an exemplary implementation of the general functionality. It is to be understood that alternative or additional messages may be included and that some messages may be omitted depending on the particular implementation.

As shown, the synchronization agent 126 sends a synchronization request 401 to the synchronization agent 155. In various implementations, the synchronization request 401 may be created in response to the user of the client computing device 110 manually invoking a synchronization command operation, created on a schedule (e.g., every certain number of minutes), in response to an external signal or message, or in any other way in accordance with the described embodiments.

In some implementations, the synchronization request 401 may be a complete request including synchronization parameters such as a synchronization command, a delay interval parameter specifying a length of a delay interval, and a collections parameter specifying one or more collections to be synchronized. In other implementations, the synchronization request 401 may comprise a partial request omitting one or more synchronization parameters, which may be filled in by the synchronization agent 155 with previous synchronization parameters in a user profile.

In some embodiments, the synchronization agent 155 may confirm the validity of the synchronization request 401. In general, the synchronization agent 155 may confirm that the synchronization request 401 is properly formatted and corresponds to collections existing on the data store 160. The synchronization agent 155 also may confirm that the parameters corresponding to the synchronization request 401 are valid. For example, the synchronization agent 155 may confirm that the user has elected at least one collection to be synchronized but no more than a maximum number set by an administrator. The synchronization agent 155 also may confirm that the delay interval parameter falls within a certain delay interval range such as between 1 second and 2700 seconds (45 minutes), for example, or within some other minimum and maximum values. In some implementations, the values and ranges for the parameters of the synchronization request 401 required by the synchronization agent 155 may be specified in various registry keys. If the synchronization request 401 is invalid for any of these reasons or others, the synchronization agent 155 may notify the synchronization agent 126 of general or specific errors and may request additional or corrected information for the synchronization request 401.

In response to the synchronization request 401, an updating session 402 is established between the synchronization agents 126, 155. The synchronization agent 155 may communicate with the data store 160 and identify any changes made for the collections corresponding to the synchronization request 401 since the last synchronization. If no changes have occurred in any of the collections identified in the collections parameter since the last synchronization, the synchronization agent 155 may inform the synchronization agent 126 that no changes have occurred and may maintain the updating session 402 and keep the synchronization request 401 pending. In some embodiments, the updating session 402 may comprise an open socket connection between the synchronization agents 126, 155, and the pending synchronization request 401 may comprise a pending HTTP request.

The synchronization agent 155 may then establish one or more subscriptions 403 with the data store 160. In various embodiments, the synchronization agent 155 may establish subscription connections for the collections identified by collections parameter. The synchronization agent 155 may listen for notifications over the subscription connections such as over one or more ports, for example. If no data updates to the collections identified by the collection parameter are received before the expiration of the delay interval, the synchronization agent may tear down the subscriptions 403 and terminate the updating session 402. The synchronization process may begin again by the synchronization agent 126 issuing a new synchronization request 401.

If during the delay interval, new data 404 is received at the data store 160 for the one or more collections to be synchronized, the synchronization agent 155 may receive a notification 405 from the data store 160. In various embodiments, the notification 405 may indicate that there are changes in the data store 160 awaiting synchronization and may identify the particular collection for which the new data 404 is received.

In some embodiments, the subscriptions 403 may be identified by one of the subscription IDs 320. In response to the notification 405 for a particular subscription, the synchronization agent 155 may identify the particular updating session 402 using the updating session IDs 318, for example, and/or the pending synchronization request 401 associated with the subscription that received the notification 405. In such embodiments, the synchronization agent 155 may reference an object, folder, table or other data structure that associates subscriptions 403 with an updating session 402. If there is no updating session corresponding to the subscriptions 403, the notification 405 is dropped by the synchronization agent 155.

Otherwise, in response to the notification 405, the synchronization agent 155 establishes a synchronization session 406 to obtain the new data 404. In some implementations, the subscriptions 403 may be torn down before performing the synchronization session 406. In various implementations, the notification 405 indicates that updated data is available, and a connection is established by the synchronization agent 155 to retrieve the updated data from the data store 160.

After receiving the updated data, the synchronization agent 155 may send a notification and synchronization response 407 to the synchronization agent 126 in response to the pending synchronization request 401. The notification and synchronization response 407 may comprise the updated data and may be sent to the synchronization agent 126 over the established updating session 402. In various implementations, the notification and synchronization response 407 may comprise a list of collections for which updated data is available. In such implementations, the notification and synchronization response 407 may be formatted as a notification message comprising synchronization data or as a synchronization message comprising notification data.

The synchronization agent 126 may provide the updated data 408 to the client data store 140 for synchronizing the collections 142 of the client computing device 110. In some cases, the synchronization agent 126 may issue another synchronization request 401 and establish another updating session 402.

In various embodiments, if when the synchronization request 401 is received, the synchronization agent 155 determines that changes have occurred in any of the collections folders since the last synchronization, the synchronization agent 155 may establish the synchronization session 406 to retrieve the new data. The synchronization agent 126 may provide the updated data 408 to the client data store 140 for synchronizing the collections of the client computing device 110.

According to various embodiments, the message flow 400 may involve the exchange of one or more messages in accordance with a synchronization protocol for communicating between the client computing device 110 and the server computing device 150. In some embodiments, the synchronization protocol may be implemented, for example, by HTTP protocol using HTTP request and response mechanisms including Unified Resource Identifiers (URIs), HTTP headers and HTTP bodies. The requests and responses may be communicated over a TCP/IP connection between the client computing device 110 and the server computing device 150 using transport layers such as GPRS, CDMA 1xRTT, IEEE 802.11, Bluetooth® (PAN), and others. In some implementations, the client computing device 110 and the server computing device 150 may communicate data formatted as compressed Wireless Binary XML (WbXML) data to make efficient use of bandwidth for mobile clients.

It can be appreciated that while some embodiments may be described as implementing the synchronization protocol in accordance with HTTP protocol, other protocols may be used including, without limitation, a Remote Procedure Call (RPC) protocol, e-mail messaging protocols, Internet protocols such as Transmission Control Protocol (TCP), web services protocols, web feed protocols such as Really Simple Syndication (RSS), and/or any other suitable synchronous or asynchronous protocols.

Operations for the above-described embodiments may be further described with reference to one or more logic flows. It may be appreciated that the representative logic flows do not necessarily have to be executed in the order presented, or in any particular order, unless otherwise indicated. Moreover, various activities described with respect to the logic flows can be executed in serial or parallel fashion. The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer).

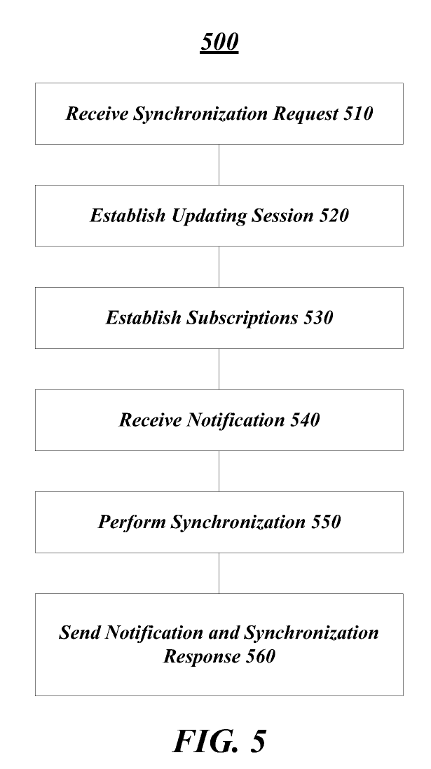

FIG. 5 illustrates one embodiment of a logic flow 500 suitable for practicing the various embodiments. The logic flow 500 may be representative of some or all of the operations executed by one or more embodiments described herein.

As shown, the logic flow 500 may comprise receiving a synchronization request 401 from a synchronization agent 126 (block 510). In some embodiments, the synchronization request may comprise a complete request including a delay interval parameter specifying a length of a delay interval and a collections parameter specifying one or more collections to be synchronized. In other embodiments, the synchronization request may comprise a partial request requiring one or more of the delay interval parameter and the collections parameter to be supplied from a user profile. The synchronization request 401 may comprise, for example, an HTTP request or any other type of request message in accordance with the described embodiments.

The logic flow 500 may comprise establishing an updating session 402 (block 520). In various embodiments, the synchronization agent 155 may establish an updating session connection with the synchronization agent 126 based on the delay interval parameter and the collections parameter associated with the synchronization request. When data for the one or more collections to be synchronized is changed, a synchronization session may be established, updated data may be retrieved, and a notification and synchronization response 407 may be sent. When data for the one or more collections to be synchronized is unchanged, the updating session connection may be maintained and the synchronization request 401 kept pending.

The logic flow 500 may comprise establishing subscriptions 403 (block 530). In various embodiments, the synchronization agent 155 may establish one or more subscription connections based on the collections parameter. The synchronization agent 155 may listen for notifications over the subscription connections.

The logic flow 500 may comprise receiving a notification 405 (block 540). In various embodiments, the synchronization agent 155 may receive a notification 405 from a data store 160 during the delay interval before the updating session 402 expires. The notification 405 may indicate that updated data is available for one or more of the collections to be synchronized.

The logic flow 500 may comprise performing synchronization (block 550). In various embodiments, the synchronization agent 155 may establish a synchronization session 406 with the data store 160 in response to the notification 405. In various implementations, the notification 405 indicates that updated data is available, and a connection is established by the synchronization agent 155 to retrieve the updated data from the data store 160.

The logic flow 500 may comprise sending a notification and synchronization response 407 (block 560). In various embodiments, the synchronization agent 155 may send a notification and synchronization response 407 to the synchronization agent 126 in response to the pending synchronization request 401. The notification and synchronization response 407 may comprise the updated data and may be sent to the synchronization agent 126 over the established updating session connection. In various implementations, the notification and synchronization response 407 may comprise a list of collections for which updated data is available. In such implementations, the notification and synchronization response 407 may be formatted as a notification message comprising synchronization data or as a synchronization message comprising notification data.

It can be appreciated that while the logic flow 500 may illustrate a certain sequence of steps, other sequences of steps may also be performed according to alternative embodiments. Moreover, some individual steps of the logic flow 500 may include multiple sub-steps that may be performed in various sequences as appropriate to the individual step. Furthermore, additional steps may be added or some steps may be removed depending on the particular implementation.

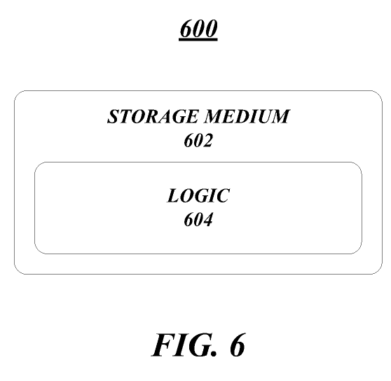

FIG. 6 illustrates a diagram an article of manufacture 600 suitable for storing logic for the various embodiments. As shown, the article of manufacture 600 may comprise a storage medium 602 to store logic 604. Examples of the storage medium 602 may include one or more types of computer-readable storage media capable of storing electronic data, including volatile memory or non-volatile memory, removable or non-removable memory, erasable or non-erasable memory, writeable or re-writeable memory, and so forth. Examples of the logic 604 may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof.

In one embodiment, for example, the article of manufacture 600 and/or the computer-readable storage medium 602 may store logic 604 comprising executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language, such as C, C++, Java, BASIC, Perl, Matlab, Pascal, Visual BASIC, assembly language, and others.

Various embodiments may be implemented using hardware elements, software elements, or a combination of both. Examples of hardware elements may include any of the examples as previously provided for a logic device, and further including microprocessors, circuits, circuit elements (e.g., transistors, resistors, capacitors, inductors, and so forth), integrated circuits, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
receiving a synchronization request from a synchronization agent;
establishing an updating session connection with the synchronization agent based on a delay interval and one or more collections to be synchronized;
maintaining the updating session connection and keeping the synchronization request pending when data for the one or more collections to be synchronized is unchanged;
receiving a notification from a data store during the delay interval indicating that updated data is available for one or more of the collections to be synchronized;
establishing a synchronization session connection with the data store for retrieving the updated data; and
sending a notification and synchronization message comprising the updated data to the synchronization agent as a response to the pending synchronization request.

2. The method of claim 1, wherein the synchronization request comprise a Hypertext Protocol request.

3. The method of claim 1, wherein in the synchronization request comprises one or more of the delay interval and the collections to be synchronized.

4. The method of claim 1, wherein the synchronization request comprises a partial request and one or more of the delay interval and the collections to be synchronized are provided from a user profile.

5. The method of claim 1, wherein the notification and synchronization message comprises a list of collections for which updated data is available.

6. The method of claim 5, wherein the notification and synchronization message is formatted as a notification message comprising synchronization data.

7. The method of claim 5, wherein the notification and synchronization message is formatted as a synchronization message comprising notification data.

8. The method of claim 1, wherein the notification and synchronization message is sent over the updating session connection.

9. The method of claim 1, further comprising:
establishing one or more subscription connections to the data store based on the collections to be synchronized; and
listening for notifications over the subscriptions connections.

10. The method of claim 1, further comprising establishing a synchronization session connection, retrieving updated data, and sending the notification and synchronization message when the data for the one or more collections to be synchronized has changed.

11. A computer-readable storage medium having computer-executable instructions stored thereon which, when executed by a computer, will cause the computer to:
establish an updating session connection with a synchronization agent in response to a synchronization request, the updating session connection to be maintained and the synchronization request kept pending for a delay interval when data is unchanged for one or more collections to be synchronized;
retrieve updated data in response to receiving a notification from a data store during the delay interval; and
send a notification and synchronization message comprising the updated data to the synchronization agent as a response to the pending synchronization request.

12. The computer-readable medium of claim 11, further comprising computer-executable instructions stored thereon which, when executed by a computer, will cause the computer to associate a delay interval parameter and a collections parameter with the synchronization request, the delay interval parameter specifying a length of the delay interval, the collections parameter specifying the one or more collections to be synchronized.

13. The computer-readable medium of claim 12, further comprising computer-executable instructions stored thereon which, when executed by a computer, will cause the computer to load a user profile and provide one or more of the delay interval parameter and the collections parameter from the user profile.

14. The computer-readable medium of claim 13, further comprising computer-executable instructions stored thereon which, when executed by a computer, will cause the computer to establish one or more subscription connections to the data store and listen for notifications over the subscriptions connections.

15. The computer-readable medium of claim 11, further comprising computer-executable instructions stored thereon which, when executed by a computer, will cause the computer to establish a synchronization session connection, retrieve updated data, and send the notification and synchronization message when the data has changed for the one or more collections since last synchronization.

16. An apparatus, comprising:
an updating session component to establish an updating session connection with a synchronization agent in response to a synchronization request, the updating session connection to be maintained and the synchronization request kept pending for a delay interval when data is unchanged for one or more collections to be synchronized; and
a synchronization component to retrieve updated data in response to receiving a notification from a data store during the delay interval and to send a notification and synchronization message comprising the updated data to the synchronization agent as a response to the pending synchronization request.

17. The apparatus of claim 16, comprising a notification component to establish one or more subscription connections to the data store for listening for notifications.

18. The apparatus of claim 17, the notification component to terminate the subscription connections after receiving a notification.

19. The apparatus of claim 16, the updating session component to terminate the updating session connection upon expiration of the delay interval if data remains unchanged for the one or more collections to be synchronized.

20. The apparatus of claim 16, the synchronization component to establish a synchronization session connection, retrieve updated data, and send the notification and synchronization message when the data has changed for the one or more collections since last synchronization.
